(19) United States
(12) Patent Application Publication
(10) Pub. No.: US 2018/0225978 A1
(43) Pub. Date: Aug. 9, 2018

(54) METHOD AND SYSTEM FOR FLIGHT PLAN DATA TRANSMISSION IN AN AIRCRAFT

(71) Applicant: AIRBUS OPERATIONS (SAS), Toulouse (FR)

(72) Inventor: Jean-Claude MERE, Verfeil (FR)

(21) Appl. No.: 15/887,267

(22) Filed: Feb. 2, 2018

(30) Foreign Application Priority Data
Feb. 3, 2017 (FR) 1750910

(51) Int. Cl. G08G 5/00; G05D 1/10; G06F 21/60

(52) U.S. Cl. CPC G08G 5/0039; G06F 21/606; G05D 1/101

(57) ABSTRACT

A device and method for safe and secure flight management of an aircraft that includes: a flight management system (3) which determines a flight path for the aircraft; a guidance module (2) which supplies command instructions to a guidance system (4) of the aircraft based on the flight path; a safe and secure interface (5) between the flight management system (3) and the guidance module (2); the flight management system (3) including a first transmission module (7a) for transmitting the flight path determined by the flight management system (3) to the guidance module (2) via the safe and secure interface (5) after the flight path has been validated by the operator; a second transmission module (7b) for transmitting the flight path to the guidance module (2) via the safe and secure interface (5) periodically or subsequent to an event likely to modify the flight path.

### RELATED APPLICATION

This application claims priority to French patent application 1750910, filed Feb. 3, 2017, the entirety of which is incorporated by reference.

### TECHNICAL FIELD

The present invention relates to a device and method for safe and secure flight management of an aircraft.

### BACKGROUND OF THE INVENTION

The current avionics architectures generally comprise at least one flight management system (FMS) within the avionics system of an aircraft. The FMS notably offers the flight crew, e.g., pilots, the ability to define a flight path prior to a flight, and to maintain or modify the flight path during the flight. The flight path is to be followed by the aircraft to carry the passengers from a starting origination, such as a departure airport, through the air and to an intended destination such as an arrival airport.

In the context of the present invention:

(i) an avionics part relates to an onboard electronic element or computer software or hardware module (processing modules, systems, etc.) of an avionics system of an aircraft. Avionics parts are safe and secure from open world parts by being configured to obey given constraints of integrity and of availability regarding the data communications with open world parts. The avionics part is secured such that data and inputs from the open world parts are limited and controlled.

(ii) an open world part relates to electronics equipment (such as a portable computer, computer tablet, smartphone and the like) used by the flight crew such as in the cockpit of the aircraft. The open world part is separate from the avionics part. The open world part hosts flight related software applications and contains flight related data. The open world part may be used to create or modify a flight path. The open world part and its applications and data are conventionally treated as being insufficiently safe and secure to communication directly to the avionics parts for use in critical functions of the aircraft.

Airline companies provide flight crews, e.g., pilots, with open world parts to aid with the planning and management of a flight mission. These open world parts may be integrated into an electronic device of EFB (Electronic Flight Bag) type or another portable computer or touchscreen tablet.

These open world parts, such as the EFB, allow the flight crew to prepare for a flight mission by preparing an intended flight path before the aircraft leaves for a flight mission. The open world parts may also be used to modify the mission, including the flight path, during flight, such as by modifying the intended flight path of an aircraft during flight.

The advantages to an airline and its crews of installing flight mission related software and data on open world parts, such as in an EFB, include time and cost reductions for mission planning, uniformity of open world flight tools across a fleet of aircraft managed by an airline, and flexibility for modification or installation of flight missions as compared to avionics parts available on an aircraft's avionics system, such as a FMS.

### DESCRIPTION OF THE INVENTION

The communication of data between an EFB and the avionics part(s) of an aircraft should be configured and secured to avoid the transmission of corrupted data or the installation of software, such as malicious software, on the avionics system of an aircraft. Corrupted data and malicious software that is loaded into the avionics system may compromise the safety or security of the aircraft. While safe and secure architectures exist which allow the transmission of information from the open world to an avionics system, there remains a need for providing secure data transfer between open world parts, such as EFBs, operated by a flight crew and the avionics of an aircraft.

The present invention provides a safety protection option which provides a safe segregation between an aircraft on-board avionics system (the avionics parts) managing an active flight plan of an aircraft in flight, based on which the aircraft is being guided, and an open world electronic system, (the open world parts such as an EFB), managing a secondary flight plan which may be used to replace or update the active flight plan.

The invention may be embodied as an interface between an open world EFB device and a flight management system, which is an avionics part. The invention may be configured to provide safe and secure flight management of an aircraft equipped with a guidance system configured for guiding the aircraft based on command instructions received from the open world EFB device.

An embodiment of the invention comprises: (i) a flight management system (FMS) configured to determine a future flight path of an aircraft; (ii) a guidance module configured to supply command instructions to a guidance system based on the flight path determined by the flight management system; and (iii) a safe and secure interface between the flight management system and the guidance module.

The flight management system may comprise: (i) a man-machine interface configured to allow an operator, e.g., pilot or other member of a flight crew, to validate a flight path; (ii) a first transmission module configured to transmit the flight path determined by the flight management system to the guidance module via the safe and secure interface after the flight path determined has been validated by the operator by means of the man-machine interface, and (iii) a second transmission module configured to transmit the flight path determined by the flight management system to the guidance module via the safe and secure interface periodically or subsequent to an event likely to modify the flight path.

The invention may be configured to insert data from an open world device, e.g. an EFB, safety and security into the avionics system of an aircraft. The flight management system communicates with the guidance module via a safe and secure interface after the flight path has been validated by the flight crew. There accordingly exists a sufficient hardware and software segregation between the active flight plan in the guidance module and the secondary flight plan(s) in the flight management system.

This segregation is used by the invention to allow data coming from an open world part to be inserted into the flight management system in complete safety and security for the crew to validate its functional content prior to insertion into the active flight plan managed by the guidance module to guide the aircraft along an active flight plan.

The flight management system may comprise:

(i) a navigation database configured for storing information useful for the calculation of a flight plan;

(ii) a first computational unit configured for calculating a flight plan using information from the navigation database; and

(iii) a second computational unit configured for calculating a flight path based on a flight plan.

Furthermore, the first computational unit may additionally be configured to revise a flight plan transmitted by the first transmission module to the guidance module. The flight plan may be revised periodically or subsequent to an event that is likely to cause a modification to the flight path.

The flight management system (FMS) may comprise:

(i) at least a first non-transitory storage module configured for storing at least one flight plan coming from the open world,

(ii) at least a second non-transitory storage module configured for storing at least one flight path calculated by the second computational unit based on the flight plan coming from the open world, and

(iii) an interface for data coming from the open world configured for transferring at least one flight plan coming from the open world into the first storage module.

The flight management system may comprise a flight plan modification module configured to transmit a flight plan revision request to the first computational unit.

The man-machine interface may comprise an electronic display screen configured for displaying the flight path calculated by the second computational unit. The guidance module may comprise:

(i) a third non-transitory storage module configured for storing the flight path determined by the flight management system; and

(ii) a fourth non-transitory storage module configured for storing the flight plan based on which the flight management system has determined said flight path, wherein the flight path and the flight plan are transmitted by the first transmission module after the flight path and optionally the flight plan have been validated by the operator, e.g., flight crew, by means of the man-machine interface, and wherein the flight path and the flight plan is transmitted by the second transmission module periodically or subsequent to an event likely to modify the flight path.

The invention may also be embodied as a method for safe and secure flight management of an aircraft equipped with a guidance system configured for guiding the aircraft based on command instructions received. The method may comprise:

(i) determining a flight path, implemented by a flight management system, including determining a flight path for the aircraft, wherein the determined flight path is not yet active as the aircrafts actual flight path,

(ii) validation of the flight path, using a man-machine interface, wherein the validation is by an operator reviewing and approving of the flight path determined by the flight management system,

(iii) a first transmission step, implemented by a transmission module, including transmitting the flight path, determined by the flight management system and validated by the operator by means of the man-machine interface, to a guidance module via a safe and secure interface,

(iv) a second transmission step, implemented by a second transmission module, including transmitting the flight path determined by the flight management system to the guidance module via the safe and secure interface periodically or subsequent to an event likely to modify the flight path, and

(v) determining command instructions, implemented by the guidance module, including determining command instructions for the guidance system based on the flight path determined by the flight management system.

The step for determining a flight path may comprise:

(i) a sub-step for calculating a flight plan, implemented by a first computational unit, including calculating a flight plan using information useful for the calculation of a flight plan stored in a navigation database, and

(ii) a sub-step for calculating a flight path, implemented by a second computational unit of the flight management system, including calculating the flight path based on the flight plan calculated by the first computational unit.

The step for determining a flight path may comprise:

(i) a sub-step for dynamic revision of the active flight path, implemented by the first computational unit, including revising the flight plan which has been transmitted by the first transmission module to the guidance module, the flight plan being revised periodically or subsequent to an event likely to modify the flight path, and

(ii) a sub-step for calculating a flight path, implemented by the computational unit of the flight management system, including calculating the flight path based on the flight plan revised by the computational unit.

The step for determining a flight path may comprise:

(i) a sub-step for storing a flight plan, implemented by a first storage module, including storing in the first storage module a flight plan coming from the open world via an interface for data coming from the open world,

(ii) a sub-step for calculating a flight path, implemented by the second computational unit, including calculating the flight path based on the flight plan stored in the first storage module, and

(iii) a storage sub-step, implemented by a second storage module, including storing the flight path in the second storage module.

The first transmission step and the second transmission step may comprise:

(i) a third storage sub-step, implemented by a third storage module, including storing the flight path determined by the flight management system, and

(ii) a fourth storage sub-step, implemented by a fourth storage module, including storing the flight plan based on which the flight management system has determined said flight path, wherein the flight path and the flight plan being transmitted during the first transmission step after the flight path determined has been validated by the operator in the validation step, and wherein the flight path and the flight plan being transmitted during the second transmission step periodically or subsequent to an event likely to modify the flight path.

The method may comprise a modification step, implemented by a modification module, including transmitting a flight plan revision request to the first computational unit.

The invention may be embodied in an aircraft, in particular a transport airplane, such as a commercial passenger airline aircraft, which comprises a safe and secure flight management device such as described hereinabove.

### BRIEF DESCRIPTION OF THE FIGURES

The invention, with its features and advantages, will become more clearly apparent upon reading the description presented with reference to the appended drawings in which:

FIG. 1 shows the safe and secure flight management device according to an embodiment of the invention;

FIG. 2 shows the safe and secure flight management method according to the embodiment shown in FIG. 1;

FIG. 3 shows an aircraft comprising the safe and secure flight management device.

### DETAILED DESCRIPTION

The following part of the description make reference to the aforementioned figures.

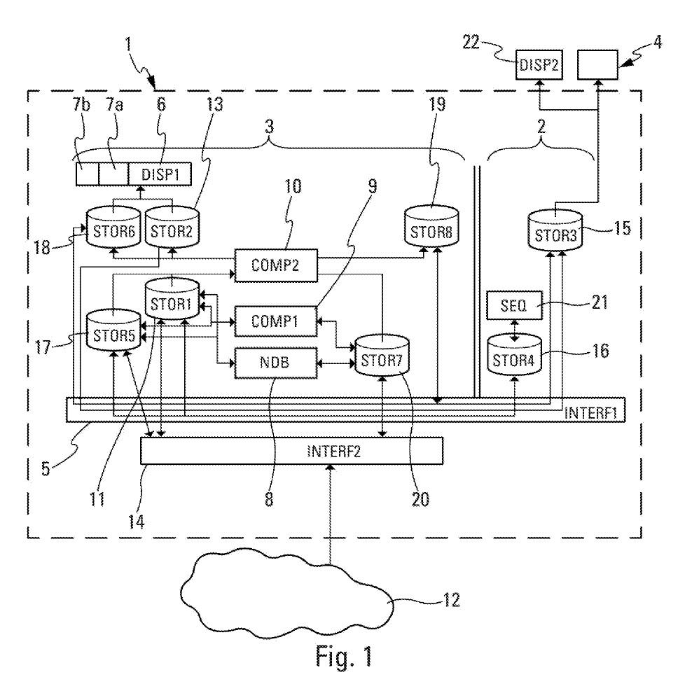

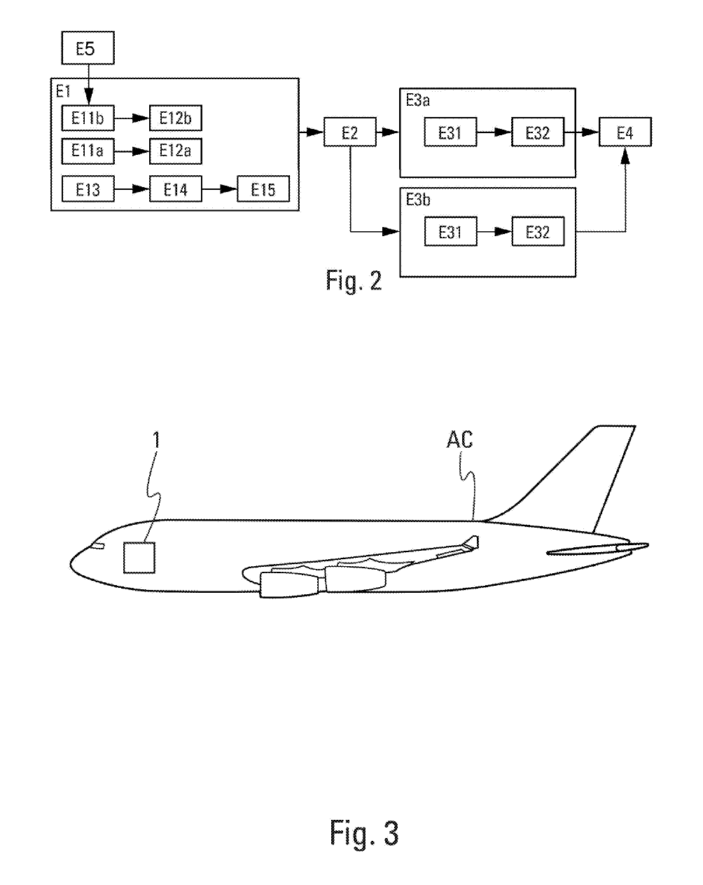

FIG. 1 illustrates one embodiment of a computer device 1 for safe and secure flight management of an aircraft AC. In the following part of the description, the term “device” corresponds to the “safe and secure flight management device of an aircraft,” The device may be embodied in or as a flight management system (FMS), which is an onboard computer system.

The device 1 is installed onboard an aircraft AC equipped with a computer guidance system 4 configured for guiding the aircraft AC based on command instructions.

The device 1 comprises a flight management system (FMS) 3 configured for determining a flight path of the aircraft AC not active at the current time.

The device 1 also comprises:

(i) a computer guidance module 2 configured for supplying command instructions to the guidance system 4 based on the flight path determined by the flight management system 3, and

(ii) a safe and secure interface 5 INTERF1 (INTERF for “Interface”) between the flight management system 3 and the guidance module 2.

The safe and secure interface 5 may correspond to an open application programming interface (or Open API).

Furthermore, the flight management system 3 comprises a man-machine interface 6 DISP1 (DISP for “DISPLAY”), configured to allow an operator (pilot) to validate a flight path.

The man-machine interface 6 may comprise a display screen configured for displaying the flight path calculated by a computerized computational unit 10. For example, the man-machine interface 6 comprises at least a touchscreen keyboard displayed on the screen or a physical keyboard allowing the flight path displayed on the screen to be validated.

Furthermore, the flight management system 3 comprises:

(i) a first electronic transmission module 7a configured for transmitting the flight path determined by the flight management system 3 to the guidance module 2 via the safe and secure interface 5 after the flight path has been validated by the operator using the man-machine interface 6,

(ii) a second electronic transmission module 7b configured for transmitting the flight path determined by the flight management system 3 to the guidance module 2 via the safe and secure interface 5 periodically or subsequent to an event likely to modify the flight path.

An event corresponds, for example, to one or more of a change in the state of the aircraft AC, to a change in the atmospheric conditions such as a change in the wind, to an input of a new flight plan, and other conditions that may affect a flight plan.

The flight management system 3 furthermore comprises:

(i) an electronic storage of a navigation database 8 NDB configured for storing information useful for the calculation of a flight plan;

(ii) a computational unit 9 COMP1 configured for calculating a flight plan using information from the navigation database 8; and

(iii) a computational unit 10 COMP2 configured for calculating a flight path based on a flight plan.

The computational unit 9 is also configured for revising a flight plan transmitted by the first transmission module 7a to the guidance module.

The flight plan may be revised periodically or subsequent to an event that affects the flight path.

The flight plans and the flight paths coming from the open world, such as the pilot's EFB, may be stored in storage modules of the flight management system 3.

According to the embodiment shown in FIG. 1, the flight management system 3 comprises:

(i) at least one electronic storage module (STOR), 11 STOR1, 17 STOR5 and 20 STOR7, each configured for storing at least one flight plan coming from the open world 12,

(ii) at least one electronic storage module 13 STOR2, 18 STOR6 and 19 STOR8 configured for storing at least one flight path calculated by the computational unit 10 based on the flight plan coming from the open world 12, and

(iii) an interface 14 INTERF2 for data coming from the open world 12 configured for transferring at least one flight plan coming from the open world 12 into the storage module 11, 17, 20.

For example, the interface 14 may correspond to the interface 5.

In the configuration shown in FIG. 1, the storage module 11 is configured for storing a secondary flight plan coming from an open world part 12. A flight plan includes information for determining a flight path of the aircraft. The storage module 13 is configured for storing a secondary flight path calculated by the computational unit 10 based on the secondary flight plan. The storage module 17 is configured for storing a temporary flight plan potentially coming from the open world part 12. The storage module 18 is configured for storing a flight path calculated by the computational unit 10 based on the temporary flight plan. The storage module 20 is configured for storing a draft flight plan coming from the open world part 12. The storage module 19 is configured for storing a draft flight path calculated based on the draft flight plan coming from the open world 12.

For example, the secondary flight plan corresponds to a flight plan revised by the computational unit 9. The secondary flight path is then calculated by the computational unit 9 based on the revised flight plan. The temporary flight plan corresponds to a flight plan input by the operator. The temporary flight plan is then calculated by the computational unit 10 based on the flight plan input by the operator. This temporary flight path is subsequently validated or otherwise by the operator by means of the man-machine interface 6. The draft flight plan and the draft flight path respectively correspond to a flight plan and a flight path used by an application external to the device 1.

Advantageously, the data stored in the storage modules 11, 17, 19 and 20 come from an electronic device of an EFB type of the open world 12. For the storage module 11, the stored data also comes from an air traffic control center (or ATC) or from an air operations center (or AOC) of the open world 12.

The flight management system 3 may comprise a computer flight plan modification module configured for transmitting a flight plan revision request to the first computational unit 9. The request comprises the revision information required for the revision of the flight plan.

The request may be input by the operator via a modification interface. The request may also be sent by the guidance module 2.

The modification interface may correspond to the man-machine interface 6. The revision information is input by the operator using a touchscreen of the man-machine interface 6 or a physical keyboard.

The modification interface may also correspond to an interface different from the man-machine interface 6. The revision information may also be input by means of a touchscreen of the interface or by means of a physical keyboard.

The modification interface may also correspond to a man-machine interface installed in an EFB system.

A new flight plan is then revised from the revision information by means of the computational unit 9.

A new flight path is then calculated based on the new flight plan by means of the computational unit 10.

Furthermore, the guidance module 2 comprises a storage module 15 STOR3 configured for storing the flight path determined by the flight management system 3. A storage module 16 STOR4 is included within the guidance module 2. This storage module 16 is configured for storing the flight plan based on which the flight management system 3 has determined said flight path

The flight path and the flight plan are transmitted by the transmission module 7a after the flight path, determined by the flight management system 3, has been validated by the operator by means of the man-machine interface 6.

The flight path and the flight plan are also transmitted by the transmission module 7b periodically or subsequent to an event likely to modify the flight path.

The guidance module 2 may comprise a sequencing module 21 SEQ configured for sequencing a portion of flight path of the current flight plan, stored in the storage module 16, as a function of the position of the aircraft.

By virtue of this device 1, a hardware and software segregation exists between the active flight plan in the guidance module 2 and the secondary flight plans in the flight management system 3, which allows, for example, data coming from the open world 12 to be inserted into the flight management system 3 in order for its functional content to be validated by the crew prior to insertion into the active flight plan for guiding the aircraft. This mechanism may also be used during flight plan revisions or modifications with the aid of a temporary flight plan which may be presented to the operator. The revisions may also be carried out in an application hosted outside of the device, such as a man-machine interface installed in an EFB system.

The management of the flight plan and of the active flight path in the guidance module 2 allows an improved integrity or availability of this flight path to be ensured for critical operations, notably operations of RNP AR (Required Navigation Performance with Authorization Required) type. The performance required for an operation of RNP type is defined by an RNP value which represents the half-width in nautical miles of the corridor around the reference flight path within which the aircraft AC must remain 95% of the time during the operation. The integrity or the availability of the flight path are ensured even when the value of the RNP is less than 0.1 Nm (around 185 m).

The device 1 such as described hereinabove implements a method for safe and secure flight management of an aircraft AC equipped with a guidance system 4 configured for guiding the aircraft AC based on command instructions received.

The invention may also be embodied as a method which comprises:

(i) a step E1 for determining a flight path, implemented by the flight management system 3, consisting in determining a flight path of the aircraft AC not active at the current time,

(i) a validation step E2, implemented by the man-machine interface 6, consisting in the validation by an operator of the flight path determined by the flight management system 3,

(iii) a transmission step E3a, implemented by the transmission module 7a, consisting in transmitting the flight path determined by the flight management system 3 to the guidance module 2 via the safe and secure interface 5,

(iv) a transmission step E3b, implemented by the transmission module 7b, consisting in transmitting the flight path determined by the flight management system 3 to the guidance module 2 via the safe and secure interface 5 periodically or subsequent to an event likely to modify the flight path, and

(v) a step E4 for determining command instructions, implemented by the guidance module 2, consisting in determining command instructions for the guidance system 4 based on the flight path determined by the flight management system 3.

The transmission step E3a is implemented for the activation of a first flight path and of a first flight plan after the operator has validated the flight path.

Then, the transmission step E3b is implemented in a dynamic phase by a periodic update or an update after an event likely to modify the flight path and the flight plan. For the transmission step E3b, the flight path is not validated by the operator. It is, for example, displayed on a display unit 22 DISP2 of the guidance module 2.

In addition, the step E1 for determining a flight path comprises:

(i) a sub-step E11a for calculating a flight plan, implemented by the computational unit 9, consisting in calculating a flight plan using information useful for the calculation of a flight plan stored in the navigation database 8; and

(ii) a sub-step E12a for calculating a flight path, implemented by the computational unit 10 of the flight management system 3, consisting in calculating the flight path based on the flight plan calculated by the computational unit 9.

In addition, the step E1 for determining a flight path comprises:

(i) a sub-step E11b for dynamic revision of the active flight path, implemented by the first computational unit 9, consisting in revising the flight plan transmitted by the first transmission module 7a to the guidance module 2. The flight plan is revised periodically or subsequent to an event likely to modify the flight path, and

(ii) a sub-step E12b for calculating a flight path, implemented by the computational unit 10 of the flight management system 3, consisting in calculating the flight path based on the revised flight plan by the computational unit 9.

According to one embodiment of the invention, the step E1 for determining a flight path comprises:

(i) a sub-step E13 for storing a flight plan, implemented by the storage module 11, 17, 20, consisting in storing in the storage module 11, 17, 20 a flight plan coming from the open world 12 via an interface 14 for data coming from the open world 12,

(ii) a sub-step E14 for calculating a flight path, implemented by the computational unit 10, consisting in calculating the flight path based on the flight plan stored in the storage module 11, 17, 20, and

(iii) a storage sub-step E15, implemented by the storage module 13, 18, 19, consisting in storing the flight path in the storage module 13, 18, 19.

The transmission step E3a and the transmission step E3b comprise:

(i) a storage sub-step E31, implemented by the storage module 15, consisting in storing the flight path determined by the flight management system 3, and

(ii) a storage sub-step E32, implemented by the storage module 16, consisting in storing the flight plan based on which the flight management system 3 has determined said flight path.

The flight path and the flight plan are transmitted during the transmission step E3a after the flight path determined has been validated by the operator in the validation step E2.

The flight path and the flight plan are transmitted during the transmission step E3b periodically or subsequent to an event likely to modify the flight path.

Furthermore, the method may comprises a modification step E5, implemented by the modification module, consisting in transmitting a flight plan revision request to the first computational unit 9. The request comprises the modification information used by the computational unit 9 for revising the flight plan according to the sub-step E11b. The revision of the flight plan consists in calculating a new flight plan based on revision information. A new flight path is then calculated based on the new flight plan by the computational unit 10 according to the sub-step E12.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A device for safe and secure flight management of an aircraft (AC) equipped with a guidance system configured to guide the aircraft (AC) based on command instructions received, the device includes:
a computer flight management system configured to determine a flight path of the aircraft (AC);
a computer guidance module configured to supply command instructions to the guidance system based on the flight path determined by the flight management system; and
a safe and secure interface between the flight management system and the guidance module;
wherein the flight management system comprises:
a man-machine interface configured to allow an operator to validate a flight path;
a first transmission module configured to transmit the flight path determined by the flight management system to the guidance module via the safe and secure interface after the flight path determined has been validated by the operator via the man-machine interface; and
a second transmission module configured to transmit the flight path determined by the flight management system to the guidance module via the safe and secure interface periodically or subsequent to an event affecting the flight path.

2. The device according to claim 1, wherein the flight management system comprises:
a navigation database configured to store information for the calculation of a flight plan;
a first computational unit configured for calculating the flight plan using information from the navigation database; and
a second computational unit configured for calculating the flight path based on the calculated flight plan.

3. The device according to claim 2, wherein the first computational unit is configured to revise the flight plan after the transmission of the flight path by the first transmission module to the guidance module, wherein the flight path is revised periodically or subsequent to the event.

4. The device according to claim 1, wherein the flight management system comprises:
at least a first storage module configured to store a flight plan transmitted from an open world part;
at least a second storage module configured to store a flight path calculated by the second computational unit based on the flight plan transmitted from the open world part; and
an interface for data coming from the open world part configured to transfer the at least one flight plan coming from the open world device into the first storage module.

5. The device according to claim 1 wherein the flight management system comprises a flight plan modification module configured to transmit a flight plan revision request to the first computational unit.

6. The device according to claim 1, wherein the man-machine interface comprises a display screen configured to display the flight path calculated by a second computational unit.

7. The device according to claim 1 wherein the guidance module comprises:
a third storage module configured to store the flight path determined by the flight management system;
a fourth storage module configured to store the flight plan based on which the flight management system has determined said flight path,
the flight path and the flight plan being transmitted by the first transmission module after the flight path determined has been validated by the operator by means of the man-machine interface, and the flight path and the flight plan being transmitted by the second transmission module periodically or subsequent to an event likely to modify the flight path.

8. A method for safe and secure flight management of an aircraft equipped with a guidance system configured for guiding the aircraft based on command instructions received, wherein the method comprises:
determine a flight path using a flight management system, wherein the flight path is determined before the aircraft embarks on the flight path;
validate the flight path by an operator of the aircraft using a man-machine interface;
a first transmission of the validated flight path by a first transmission module to the guidance module and via an interface,
a second transmission by a second transmission module, including transmitting the flight path determined by the flight management system to the guidance module via the safe and secure interface periodically or subsequent to an event likely to modify the flight path, and
determining command instructions implemented by the guidance module, wherein the determined command instructions are for the guidance system and based on the flight path determined by the flight management system.

9. The method according to claim 8, wherein the step for determining a flight path comprises:
a sub-step for calculating a flight plan, implemented by a first computational unit, including calculating a flight plan using information useful for the calculation of a flight plan stored in a navigation database; and
a sub-step for calculating a flight path, implemented by a second computational unit of the flight management system, including calculating the flight path based on the flight plan calculated by the first computational unit.

10. The method according to claim 8 wherein the step for determining a flight path comprises:
a sub-step for dynamic revision of the active flight path, implemented by the first computational unit, including revising the flight plan which has been transmitted by the first transmission module to the guidance module, the flight plan being revised periodically or subsequent to an event likely to modify the flight path, and
a sub-step for calculating a flight path, implemented by the computational unit of the flight management system, including calculating the flight path based on the flight plan revised by the computational unit.

11. The method according to claim 7, wherein the step for determining a flight path comprises:
a sub-step for storing a flight plan, implemented by a first storage module, consisting in storing in the first storage module a flight plan coming from the open world via an interface for data coming from the open world,
a sub-step for calculating a flight path, implemented by the second computational unit, including calculating the flight path based on the flight plan stored in the first storage module, and
a storage sub-step, implemented by a second storage module, including storing the flight path in the second storage module.

12. The method according to claim 7, wherein the first transmission step and the second transmission step comprise:
a third storage sub-step, implemented by a third storage module, including storing the flight path determined by the flight management system,
a fourth storage sub-step, implemented by a fourth storage module, including storing the flight plan based on which the flight management system has determined said flight path,
the flight path and the flight plan being transmitted during the first transmission step after the flight path determined has been validated by the operator in the validation step, and
the flight path and the flight plan being transmitted during the second transmission step periodically or subsequent to an event affecting the flight path.

13. The method according to claim 8, further comprising a modification step, implemented by a modification module, including transmitting a flight plan revision request to the first computational unit.

14. A method for flight management of an aircraft equipped with a flight management system, a guidance system and a first interface device providing data communications between the flight management system and the guidance system, wherein the method comprises:
generating a flight plan using an open world part for an aircraft prior to departure of the aircraft;
transmission of the flight plan from the open world part to the flight management system via a second interface device providing data communications between the open world part and the flight management system;
storing the flight plan in the flight management system;
generating a flight path by the flight management system based on the flight plan transmitted from the open world device to the flight management system;
receipt of a validation of the flight path by a flight crew for the aircraft using a man-machine interface for the flight management system;
transmission of the validated flight path from the flight management system to the guidance system via the first interface device;
determining by the guidance system command instructions from the validated flight path;
controlling the aircraft by the guidance system based on the command instructions to cause the aircraft to fly the validated flight path;
during the flight of the aircraft, modifying the flight plan stored in the flight management system by the flight management system;
receipt of a validation of the modified flight path by the flight crew using the man-machine interface;
transmission of the validated, modified flight path from the flight management system to the guidance system;
determining by the guidance system additional command instructions from the validated, modified flight path; and
controlling the aircraft by the guidance system based on the additional command instructions to cause the aircraft to fly the validated, modified flight path.

15. The method of claim 14 wherein the step of modifying the flight path is performed at periodic intervals or in response to an event affecting the flight of the aircraft.
